(19) United States
(12) Patent Application Publication
(10) Pub. No.: US 2004/0262120 A1
(43) Pub. Date: Dec. 30, 2004

(54) Adjustable conveyor system

(76) Inventor: Donald L. LeCroy, Mableton, GA (US)

Correspondence Address: Eric T. Krischke, Pauley Petersen & Erickson, Suite 365, 2800 West Higgins Road, Hoffman Estates, IL, 60195, US

(21) Appl. No.: 10/830,864

(22) Filed: Apr. 23, 2004

Related U.S. Application Data
(60) Provisional application No. 60/464,910, filed on Apr. 23, 2003.

(51) Int. Cl. B65G 11/14

(52) U.S. Cl. 193/30; 198/861.1

(57) ABSTRACT

A conveyor system including a first fixed conveyor section fixedly positioned with respect to a supporting surface and a second fixed conveyor section positioned with respect to the first fixed conveyor section, and fixedly positioned with respect to the supporting surface. An adjustable conveyor section is initially positioned with respect to the first fixed conveyor section, and slidably movable with respect to the first fixed conveyor section to an operating position between a minimum position and a maximum position, and connectable to each fixed conveyor section.

### CROSS REFERENCE TO RELATED APPLICATION

This application claims the benefit of U.S. Provisional Application No. 60/464,910 filed 23 Apr. 2003.

### BACKGROUND OF THE INVENTION

1. Field of the Invention

This invention relates generally to a conveyor system having an adjustable conveyor section initially positioned with respect to a fixed conveyor section and slidably movable with respect to an end portion of the fixed conveyor section to connect to a second fixed conveyor section and provide a continuous conveyor bed having a desired conveyor bed length.

2. Description of Related Art

Conventional conveyor systems have been designed to fit exactly into locations as individual sections. This design method proves to be costly to engineer and manufacture by adding time and extra effort. It also seldom proves to be perfectly accurate in that installers often find it necessary to adjust conveyor lengths onsite, typically by cutting down some sections and re-welding the pieces together, which requires additional time and cost.

### SUMMARY OF THE INVENTION

A general object of the invention is to provide an improved conveyor system.

A more specific object of the invention is to provide a conveyor system forming a continuous conveyor bed wherein at least a portion of the conveyor bed is adjustable to conform to building and machine lay outs and design specifications.

The general object of the invention can be attained through a conveyor system including at least one fixed conveyor section, such as a standard drive section or a slider bed section, and at least one adjustable conveyor section operatively connected to the fixed conveyor section. Preferably, the adjustable conveyor section corresponds to a profile of the fixed conveyor section and is movable in a telescoping manner to extend and/or retract with respect to the fixed conveyor section to a desirable or suitable length and/or configuration. The adjustable conveyor section is preferably slidably movable with respect to the fixed conveyor section between an initial or first position and an operating or second position. In the initial position, the adjustable conveyor section is positioned within the fixed conveyor section. The adjustable conveyor section is slidably movable to extend or retract with respect to an end portion of the fixed conveyor section.

In one preferred embodiment of this invention, the adjustable conveyor section further includes laterally opposing walls which extend along at least a portion of a length of the adjustable conveyor section. Each adjustable conveyor section wall has a connecting element that is connected to at least a portion of a corresponding fixed conveyor section wall, to allow the adjustable conveyor section to move or translate along at least a portion of a length of the corresponding fixed conveyor section wall.

The adjustable conveyor section can be produced as a standard section and eliminates the need for various sections having different fixed lengths. In one preferred embodiment of this invention, each adjustable conveyor section comprises a moving or sliding bed section and fixed support bottom rails. The adjustable conveyor section fits within a standard drive section or slider bed section having a length of about five (5) feet to about ten (10) feet for example, providing a smooth transition from an upstream fixed conveyor section to a downstream fixed conveyor section. The adjustable conveyor bed section can be adjusted over its operational length to produce the desired overall final conveyor length. The adjustable conveyor section is shipped to the field temporarily married to the fixed conveyor section, such as a drive section or a slider bed section. When installed in the field, the adjustable conveyor section is adjusted to the desired length and permanently mounted into place. The conveyor system according to the present invention reduces engineering hours, manufacturing costs, and simplifies tracking and field installation.

The prior art generally fails to provide a conveyor system having at least one adjustable conveyor section that can be positioned between a first fixed conveyor section and a second fixed conveyor section, wherein a bed section length of the adjustable conveyor section can be adjusted between an initial position and an operating position to provide a transition between the fixed conveyor sections.

The invention further comprehends a method for constructing a conveyor system wherein a first fixed conveyor section is fixedly positioned with respect to a supporting surface, such as a building floor, and a second fixed conveyor section is fixedly positioned with respect to the first fixed conveyor section. An adjustable conveyor section is slidably movable with respect to the first fixed conveyor section between the initial position, wherein the adjustable conveyor section is positioned within the first fixed conveyor section, and the operating position, wherein the adjustable conveyor section is connected to the first fixed conveyor section at a first end portion of the adjustable conveyor section and connected to the second fixed conveyor section at a second end portion of the adjustable conveyor section. Preferably, an inner surface of the adjustable conveyor section is aligned and/or flush with an inner surface of each of the first fixed conveyor section and the second fixed conveyor section.

The telescoping adjustable conveyor section is provides for an efficient method for fitting conveyor systems into appropriate areas in an accurate and cost-effective manner. The flexibility of its design allows the conveyor installers to quickly and easily set the size of the adjustable conveyor section to meet system needs. It also allows designers to engineer and manufacturers to build conveyor sections at a uniform size, wherein a conveyor bed length can be adjusted as needed. In this manner, adjustable conveyor sections can be mass-produced in sections of 2.5 feet, 5 feet and 10 feet, for example, and when the need arises, a necessary adjustment in conveyor length can be made so that the adjustable conveyor section properly fits the system design and space requirements. The adjustable conveyor bed length range for the telescoping sections is preferably about 1 foot to about 4 feet, more preferably about two feet. The design and field-fit for the sections preferably fall within this measurement range to provide the strength and support required for the conveyor system.

Thus, in one preferred embodiment of this invention, the telescoping adjustable conveyor section is an engineered and manufactured conveyor bed section insert that allows conveyor system engineers, designers, manufacturers and contractors to install conveyor systems, which provide more flexibility at the site for fitting conveyor systems into designated areas.

Other objects and advantages will be apparent to those skilled in the art from the following detailed description taken in conjunction with the appended claims and drawings.

### BRIEF DESCRIPTION OF THE DRAWINGS

FIG. 1 shows a conveyor system including a fixed conveyor section and an adjustable conveyor section slidably movable with respect to the fixed conveyor section, wherein the adjustable conveyor section is positioned at a minimum adjustable position, according to one preferred embodiment of this invention;

FIG. 2 shows a conveyor system including a fixed conveyor section and an adjustable conveyor section slidably movable with respect to the fixed conveyor section, wherein the adjustable conveyor section is positioned at an operating position, according to one preferred embodiment of this invention;

FIG. 3 shows a conveyor system including a fixed conveyor section and an adjustable conveyor section slidably movable with respect to the fixed conveyor section, wherein the adjustable conveyor section is positioned at a maximum adjustable position, according to one preferred embodiment of this invention;

FIG. 4 shows an adjustable conveyor section, according to one preferred embodiment of this invention;

FIG. 5 shows an adjustable conveyor section movably mounted or connected to a fixed conveyor section, according to one preferred embodiment of this invention;

FIG. 6 shows an inner surface of an adjustable conveyor section, according to one preferred embodiment of this invention;

FIG. 7 shows a conveyor system, according to one preferred embodiment of this invention;

FIG. 8 shows a conveyor system, according to one preferred embodiment of this invention;

FIG. 9 shows a conveyor bed of a conveyor system, according to one preferred embodiment of this invention; and

FIG. 10 shows an adjustable conveyor section connected to a fixed conveyor section, according to one preferred embodiment of this invention.

### DETAILED DESCRIPTION OF THE INVENTION

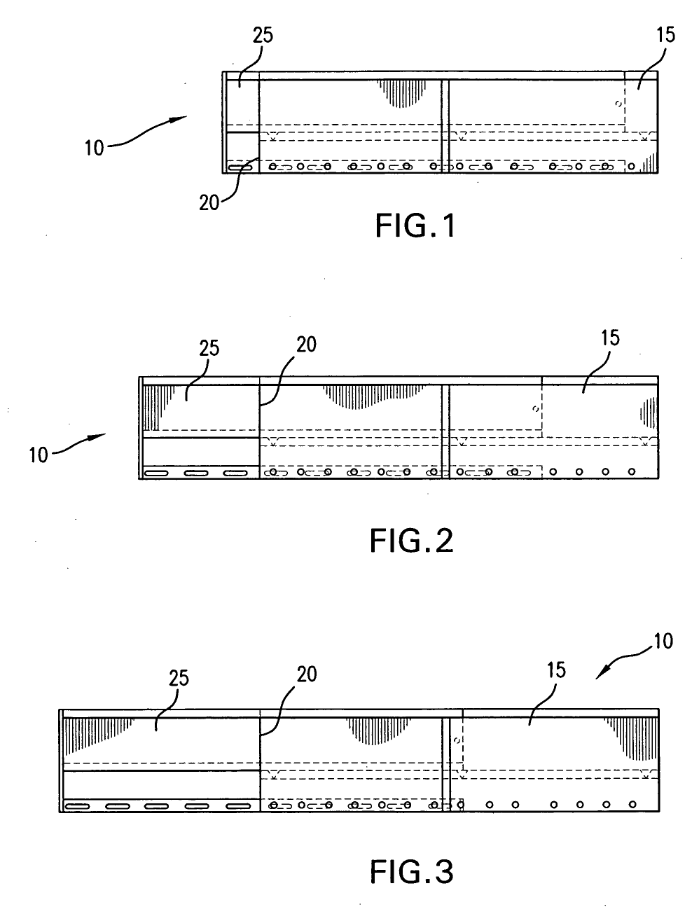

FIGS. 1-3 show a conveyor system 10 comprising at least one fixed conveyor section 15 and at least one adjustable conveyor section 25 movably mounted or connected to fixed conveyor section 15. Preferably, adjustable conveyor section 25 is slidably movable with respect to fixed conveyor section 15 to a desired operating length or operating position, as shown in FIG. 2. The operating position can be any desired position between and including an initial or minimum adjustable conveyor length or position, as shown in FIG. 1, and a maximum adjustable conveyor length or position, as shown in FIG. 3.

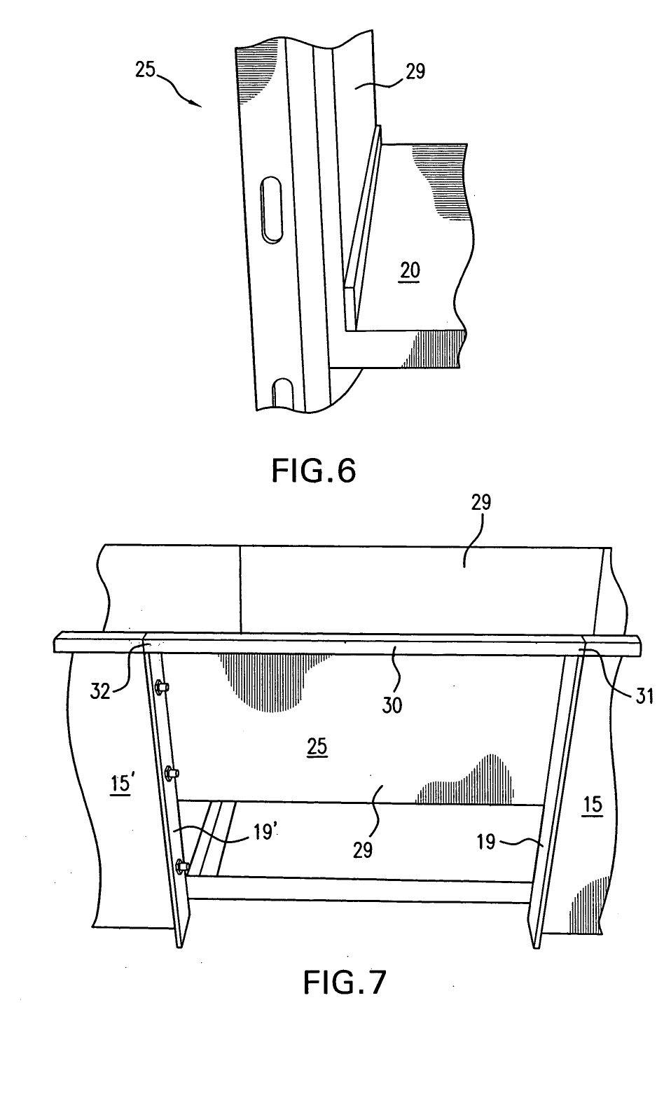

Referring to FIGS. 1-10, the present invention provides a conveyor system 10 comprising at least one fixed conveyor section 15, such as a standard drive section or a slider bed section. Preferably, fixed conveyor section 15 has a conveyor bed portion length of about 5 feet to about 10 feet. Conveyor system 10 may comprise any desired number of fixed conveyor sections in series, such as two fixed conveyor sections attached or connected together, or separated by at least one adjustable conveyor section 25. It should be apparent to those having ordinary skill in the art that fixed conveyor section 15 may have a conveyor bed portion length of any suitable length, for example less than about 5 feet or greater than about 10 feet, if necessary. Fixed conveyor section 15 is preferably fastened, connected or fixed to a support surface 100, such as a building floor, using any suitable mechanical connection known to those having ordinary skill in the art, such as anchored bolts. In one preferred embodiment of this invention, each fixed conveyor section 15 comprises at least one support leg 16 that is fixed to supporting surface 100. A height and/or a lateral width of support leg 16 is preferably adjustable to allow for leveling fixed conveyor section 15 with respect to support surface 100 and/or associated conveyor system sections.

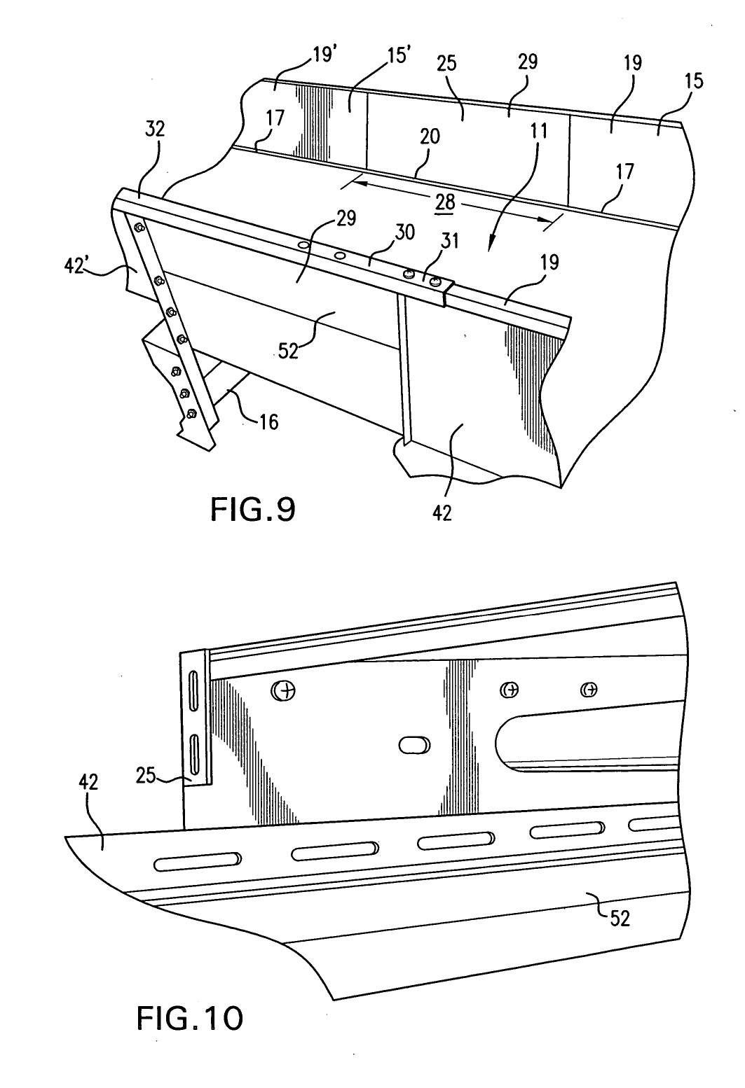

Adjustable conveyor section 25 is positionable with respect to fixed conveyor section 15 and operatively connectable to fixed conveyor section 15. Preferably, adjustable conveyor section 25 is movably mounted or connected to fixed conveyor section 15 and slidably movable with respect to fixed conveyor section 15 to a desired operating length or position between the initial or minimum adjustable conveyor bed length or position and the maximum adjustable conveyor bed length or position. Preferably, at the minimum adjustable conveyor bed length or position, a conveyor bed portion 28 of adjustable conveyor section 25, as shown in FIG. 9, has a length of about 2.5 feet to about 10 feet and at the maximum adjustable conveyor bed length or position, conveyor bed portion 28 has a length of up to about 14 feet. It is apparent to those skilled in the art that the minimum adjustable conveyor length can be less than 2.5 feet and/or the maximum adjustable conveyor length can be greater than about 14 feet, depending upon field or construction limitations and restrictions, and the desired overall operating length of conveyor system 10. Conveyor system 10 may comprise any number of adjustable conveyor sections 25 positioned between two fixed conveyor sections 15 and/or connected in series. Additionally, adjustable conveyor section 25 and/or fixed conveyor section 15 may comprise a bed section having any suitable length, width and/or depth. Further, adjustable conveyor section 25 and/or fixed conveyor section 15 may have any suitable shape and/or configuration along the bed portion length. For example, at least a portion of the bed portion may be non-linear, such as having a curved or arcuate shape or configuration.

In one preferred embodiment of this invention, adjustable conveyor section 25 is initially positioned within fixed conveyor section 15 and movably mounted or connected to fixed conveyor section 15. With adjustable conveyor section 25 in the initial position, conveyor system 10 can be easily shipped to the field with adjustable conveyor section 25 temporarily married to fixed conveyor section 15.

Adjustable conveyor section 25 is slidably movable to extend or retract with respect to an end portion 20 of fixed conveyor section 15 from the initial position defining the minimum adjustable conveyor length or position and the operating position. The minimum adjustable conveyor length and the maximum adjustable conveyor length preferably are predetermined so that adjustable conveyor system 10 can fit within a specified or desired conveyor system operating length. The conveyor system operating length is equal to the sum of the bed length of each fixed conveyor section and the bed length of each adjustable conveyor section comprising the conveyor system.

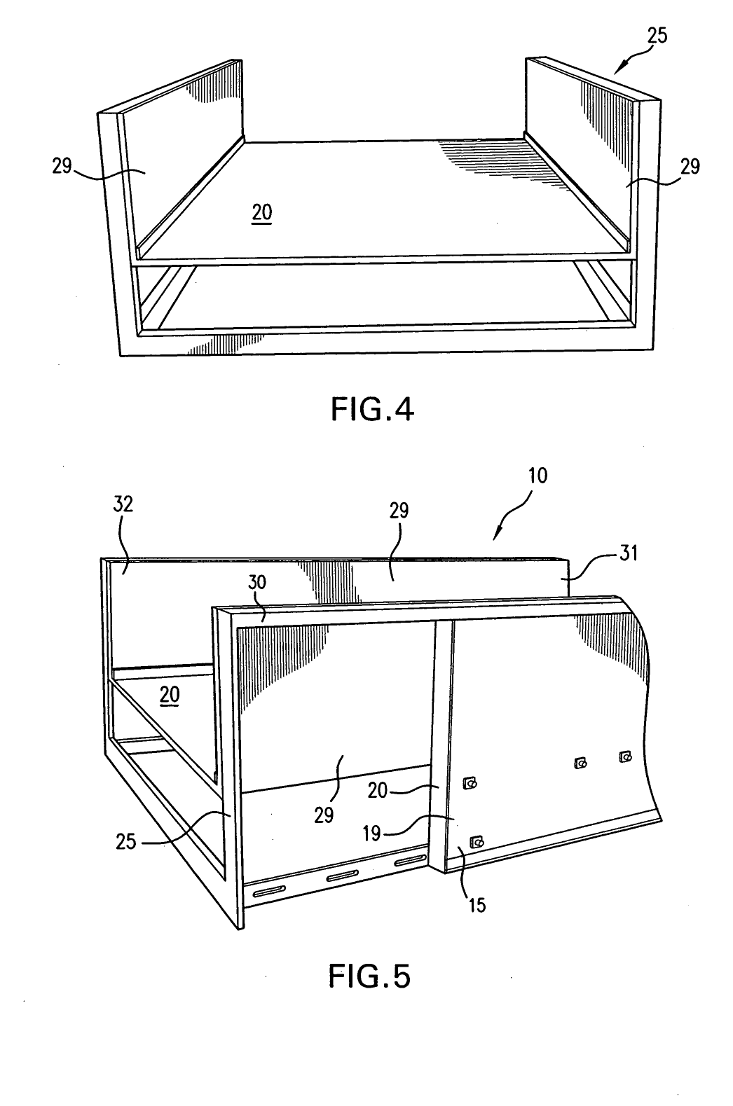

In one preferred embodiment of this invention, adjustable conveyor section 25 comprises laterally opposing side walls 29 extending along at least a portion of a length of adjustable conveyor section 25, as shown for example in FIGS. 4-9. Walls 29 preferably comprise a suitable connecting element or member operatively connected to at least a portion of a corresponding fixed conveyor section wall 19 as shown in FIG. 5, to allow each adjustable conveyor section wall 29 to slidably move or translate along at least a portion of a length of the corresponding fixed conveyor section wall 19. For example, each adjustable conveyor section wall 29 may comprise a lip portion 30 that rests on and/or contacts at least a portion of corresponding fixed conveyor section wall 19. Wall 19 supports corresponding adjustable conveyor section wall 29 to allow adjustable conveyor section 25 to move along the length of fixed conveyor section 15. In one preferred embodiment of this invention, wall 19 and/or wall 29 may include a track or guide to allow adjustable conveyor section 25 to move freely and easily along fixed conveyor section 15. Further, ball bearings and/or any other suitable mechanical element may be positioned on or between wall 19 and wall 29 to assist in movement of adjustable conveyor section 25 with respect to fixed conveyor section 15.

In one preferred embodiment of this invention, conveyor system 10 comprises a first fixed conveyor section 15 positioned with respect to supporting surface 100 and fixedly connected to support surface 100. A second fixed conveyor section 15′ is positioned with respect to first fixed conveyor section 15. Second fixed conveyor section 15′ can be positioned at an upstream position or at a downstream position with respect to first fixed conveyor section 15, for example. Second fixed conveyor section 15′ is positioned with respect to supporting surface 100 and fixedly connected to support surface 100.

Adjustable conveyor section 25, preferably but not necessarily initially positioned within first fixed conveyor section 15, is slidably movable with respect to first fixed conveyor section 15 to the desired operating length or position. At the desired operating position, adjustable conveyor section 25 is connected to first fixed conveyor section 15 at a first end portion 31 of adjustable conveyor section 25 and adjustable conveyor section 25 is connected to second fixed conveyor section 15′ at a second end portion 32 of adjustable conveyor section 25. Adjustable conveyor section 25 is attached or connected to first fixed conveyor section 15 and second fixed conveyor section 15′ using any suitable mechanical connection, such as at least one of a nut and bolt arrangement, a lag bolt, a screw and a weld spot. Adjustable conveyor section 25 can be adjusted over its operating length to provide conveyor system 10 having a desired overall conveyor length. Adjustable conveyor section 25 is connected between first fixed conveyor section 15 and second fixed conveyor section 15′ to provide a smooth transition from the upstream fixed conveyor section and the downstream fixed conveyor section. Inner surface 20 of adjustable conveyor section 25 is preferably aligned or flush with an inner surface 17 of each of first fixed conveyor section 15 and second fixed conveyor section 15′. In one preferred embodiment of this invention, adjustable conveyor section 25 provides a smooth transition between first fixed conveyor section 15 and second fixed conveyor section 15′ wherein at least one of a conveyor bed length and a conveyor bed width of the first fixed conveyor section is different from at least one of a conveyor bed length and a conveyor bed width of the second fixed conveyor section, respectively.

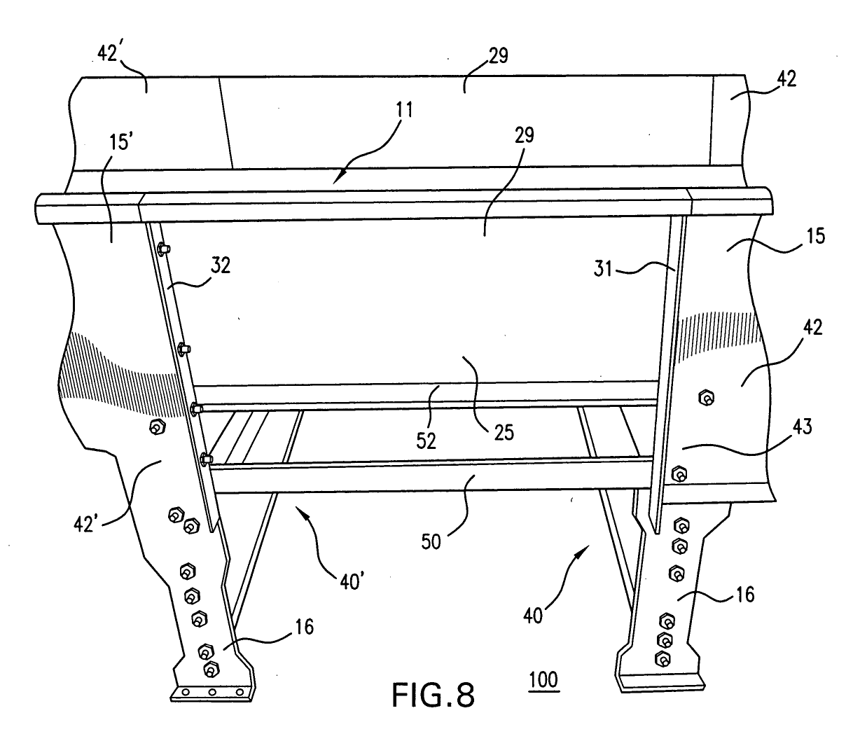

Referring to FIGS. 7-10, in one preferred embodiment of this invention, first fixed conveyor section 15 is positioned, for example, according to a floor plan, and fastened or fixed to suitable supporting surface 100, such as a building floor. First conveyor section 15 can be fastened to the floor using any suitable mechanical connector known to those having ordinary skill in the art, such as an anchored bolt. For example, as shown in FIG. 8, each fixed conveyor section 15 may comprise at least one adjustable support leg 16 that can be fastened to the floor or another supporting surface 100. Preferably, but not necessarily, a height and/or a width of support leg 16 is adjustable, as shown in FIG. 8. A second fixed conveyor section 15′ is positioned with respect to first fixed conveyor section 15 as required, for example according to the floor plan, and fastened or fixed to a suitable supporting surface 100. Second fixed conveyor section 15′ can be positioned upstream or downstream from first fixed conveyor section 15, for example. Second fixed conveyor section 15′ may or may not have the same or similar dimensions (conveyor bed length, bed width, bed depth) as first fixed conveyor section 15, depending upon the desired application and design requirements for conveyor system 10.

With first fixed conveyor section 15 and second fixed conveyor section 15′ securely positioned with respect to the other, adjustable conveyor section 25 is slidably movable with respect to first fixed conveyor section 15 between the initial position and the operating position to connect first fixed conveyor section 15 with second fixed conveyor section 15′, as shown in FIGS. 7-9. After adjustable conveyor section 25 is positioned at the desired operating position, adjustable conveyor section 25 can be fastened or connected to first fixed conveyor section 15 at first end portion 31 and to second fixed conveyor section 15′ at second end portion 32. It is apparent to those skilled in the art that conveyor sections 15, 15′ and 25 can be fastened or connected using any suitable mechanical connector, such as a nut and carriage bolt arrangement, a lag bolt, a screw and/or a weld.

Preferably, adjustable conveyor section 25 is connected to each of first fixed conveyor section 15 and second fixed conveyor section 15′ so that inner surface 20 of adjustable conveyor section 25 is flush with inner surface 17 of each fixed conveyor section 15, 15′. It is apparent to those having ordinary skill in the art that one or more adjustable conveyor sections 25 can be connected in series and/or one or more fixed conveyor sections 15, 15′ can be connected in series, depending upon the desired length, configuration and design requirements of conveyor system 10.

Referring to FIG. 8, in one preferred embodiment of this invention, each fixed conveyor section 15 preferably comprises a base portion 40 that is fastened or fixed to supporting surface 100, and a conveyor bed portion 42 which forms with the associated or connected sections the conveyor bed 11 of conveyor system 10. For example, a second fixed conveyor section 15′ having a base portion 40′ can be fastened or fixed to supporting surface 100 and a bed portion 42′ of second fixed conveyor section 15′ can be positioned with respect to first fixed conveyor section bed portion 42. Adjustable conveyor section 25 preferably, but not necessarily, comprises a base portion 50 that is fastened or fixed with respect to supporting surface 100 and a bed portion 52 that is slidably connected to first fixed conveyor section bed portion 42. Adjustable conveyor section bed portion 52 is slidably movable with respect to an end portion 43 of first fixed conveyor section bed portion 42 between the initial position and the operating position to connect first fixed conveyor section bed portion 42 and second fixed conveyor section bed portion 42′ to form conveyor bed 11. Conveyor bed 11 may comprise at least one portion that is non-linear, for example being curved or having an arcuate shape or configuration along at least a portion of a length of conveyor bed 11.

Thus, the invention provides a telescoping adjustable conveyor section that allows conveyor system engineers, designers, manufacturers and contractors to install conveyor systems, which provide more flexibility at the site for fitting conveyor sections into designated areas. Historically conveyor systems have been designed to fit exactly into locations as individual sections, which proves to be costly to engineer and manufacture by adding time and extra effort to the process. It also seldom proves to be accurate, in that installers often find it necessary to adjust conveyor lengths onsite, typically by cutting down some sections and re-welding the pieces together, which requires additional time and costs.

The telescoping adjustable conveyor section of the present invention provides an efficient method for fitting conveyor systems into appropriate areas in an accurate and cost-effective manner. The flexibility of the conveyor system design allows the conveyor system installers to quickly and easily set the size of the adjustable conveyor section to meet conveyor system needs. The conveyor system of the present invention also allows designers to engineer and manufacturers to build adjustable conveyor sections at a uniform size, having adjustable conveyor bed sections that are adjustable to a desired or suitable bed length. In this manner, adjustable conveyor sections can be mass-produced in sections having a length of about 2.5 feet to about 10 feet. The adjustable conveyor section can be used to properly fit the conveyor system within design and space requirements. The adjustable range for the telescoping adjustable conveyor sections is preferably about 1 foot to about 4 feet, more preferably about 2 feet. The design and field-fit for the sections preferably fall within these measurements to provide the strength and support required for the conveyor system.

In the drawings of various embodiments of this invention, various elements of this invention comprise a particular material. However, it is apparent to those skilled in the art that the elements may comprise any suitable material, including but not limited to metals, alloys, plastics, graphite materials and composite materials.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A conveyor system comprising:
a fixed conveyor section; and
an adjustable conveyor section positionable with respect to the fixed conveyor section and operatively connectable to the fixed conveyor section, the adjustable conveyor section movable with respect to the fixed conveyor section between a first position and a second position.

2. The conveyor system of claim 1 wherein the adjustable conveyor section is extendable from the first position.

3. The conveyor system of claim 1 wherein the adjustable conveyor section is slidably movable with respect to the fixed conveyor section.

4. The conveyor system of claim 1 wherein, in the first position, at least a portion of the adjustable conveyor section is positioned within the fixed conveyor section.

5. The conveyor system of claim 1 wherein the adjustable conveyor section is slidably movable to extend or retract with respect to an end portion of the fixed conveyor section.

6. The conveyor system of claim 1 wherein the first position defines a minimum adjustable conveyor bed length, and the second position defines a maximum adjustable conveyor bed length.

7. The conveyor system of claim 6 wherein the minimum adjustable conveyor bed length is about 2.5 feet.

8. The conveyor system of claim 6 wherein the maximum adjustable conveyor bed length is about 14 feet.

9. The conveyor system of claim 1 wherein the adjustable conveyor section has an adjustable range of about 1 foot to about 4 feet.

10. The conveyor system of claim 1 wherein the adjustable conveyor section further comprises laterally opposing adjustable conveyor section walls extending along at least a portion of a length of the adjustable conveyor section.

11. The conveyor system of claim 10 wherein each adjustable conveyor section wall of the opposing adjustable conveyor section walls comprises a connecting element operatively connected to at least a portion of a corresponding fixed conveyor section wall, each adjustable conveyor section wall movable along at least a portion of a length of the corresponding fixed conveyor section wall.

12. The conveyor system of claim 1 wherein at least two adjustable conveyor sections are connected in series.

13. The conveyor system of claim 1 wherein at least two fixed conveyor sections are connected in series.

14. A conveyor system comprising:
a first fixed conveyor section positioned with respect to a supporting surface;
a second fixed conveyor section positioned with respect to the first fixed conveyor section and operatively connectable to the first fixed conveyor section, the second fixed conveyor section positioned with respect to the supporting surface; and
an adjustable conveyor section slidably movable with respect to the first fixed conveyor section and the second fixed conveyor section between a minimum adjustable conveyor position and a maximum adjustable conveyor position, to connect the first fixed conveyor section and the second fixed conveyor section.

15. The conveyor system of claim 14 wherein each fixed conveyor section comprises at least one adjustable support leg fixed with respect to the supporting surface.

16. The conveyor system of claim 15 wherein at least one of a height and a width of the support leg is adjustable.

17. The conveyor system of claim 14 wherein the second fixed conveyor section is positioned at one of an upstream position and a downstream position with respect to the first fixed conveyor section.

18. The conveyor system of claim 14 wherein at least one of a conveyor bed length and a conveyor bed width of the first fixed conveyor section is different from at least one of a conveyor bed length and a conveyor bed width of the second fixed conveyor section.

19. The conveyor system of claim 14 wherein the adjustable conveyor section is connected to the first fixed conveyor section at a first end portion of the adjustable conveyor section and the adjustable conveyor section is connected to the second fixed conveyor section at a second end portion of the adjustable conveyor section.

20. The conveyor system of claim 14 wherein an inner surface of the adjustable conveyor section is flush with an inner surface of each of the first fixed conveyor section and the second fixed conveyor section.

21. A method for constructing a conveyor system comprising:
fixing a first fixed conveyor section with respect to a supporting surface;
fixing a second fixed conveyor section with respect to the first fixed conveyor section;
moving an adjustable conveyor section with respect to the first fixed conveyor section and the second fixed conveyor section between a first position, wherein at least a portion of the adjustable conveyor section is positioned within the first fixed conveyor section, and a second position; and
connecting the adjustable conveyor section to the first fixed conveyor section at a first end portion of the adjustable conveyor section and connecting the adjustable conveyor section to the second fixed conveyor section at a second end portion of the adjustable conveyor section.

22. The method of claim 21 wherein each fixed conveyor section further comprises at least one adjustable support leg fastenable to the supporting surface.

23. The method of claim 22 wherein a height and a width of the support leg is adjustable.

24. The method of claim 21 wherein the adjustable conveyor section is connected to each of the first fixed conveyor section and the second fixed conveyor section using at least one of a nut and bolt arrangement, a lag bolt, a screw and a weld.

25. The method of claim 21 wherein, in the second position, an inner surface of the adjustable conveyor section is flush with an inner surface of each of the first fixed conveyor section and the second fixed conveyor section.

26. The method of claim 21 wherein at least two adjustable conveyor sections are connected in series.

27. The method of claim 21 wherein at least two fixed conveyor sections are connected in series.

28. A conveyor system comprising:
a first fixed conveyor section having a base portion fixed with respect to a supporting surface, and a bed portion;
a second fixed conveyor section having a base portion fixed with respect to the supporting surface, and a bed portion positioned with respect to the first fixed conveyor section bed portion; and
an adjustable conveyor section having a base portion fixed with respect to the supporting surface, and a bed portion slidably connected to the first fixed conveyor section bed portion, the adjustable conveyor section bed portion slidably movable with respect to an end portion of the first fixed conveyor section bed portion between a minimum position and a maximum position to connect the first fixed conveyor section bed portion and the second fixed conveyor section bed portion to form a continuous conveyor bed.

29. The conveyor system of claim 28 wherein the adjustable conveyor section bed portion comprises opposing side walls, each side wall forming a lip contacting a portion of a corresponding side wall of the first fixed conveyor section.

30. The conveyor system of claim 28 wherein at least a portion of the continuous conveyor bed is non-linear.
